(19) United States
(12) Patent Application Publication
(10) Pub. No.: US 2025/0006953 A1
(43) Pub. Date: Jan. 2, 2025

(54) METAL BIPOLAR PLATE PROTECTIVE COATING OF FUEL CELL, AND PREPARATION METHOD AND APPLICATION THEREOF

(71) Applicant: GUANGDONG UNIVERSITY OF TECHNOLOGY, Guangzhou (CN)

(72) Inventors: Qimin WANG, Guangzhou (CN); Wei DAI, Guangzhou (CN); Zhetong ZHOU, Guangzhou (CN); Haiqing LI, Guangzhou (CN); Yuxiang XU, Guangzhou (CN); Zhengtao WU, Guangzhou (CN)

(21) Appl. No.: 18/628,689

(22) Filed: Apr. 6, 2024

(30) Foreign Application Priority Data
Jun. 30, 2023 (CN) 2023107996972

(51) Int. Cl. H01M 8/0228; H01M 8/0208

(52) U.S. Cl. CPC H01M 8/0228; H01M 8/0208

(57) ABSTRACT

Disclosed is a metal bipolar plate protective coating of a fuel cell, and a preparation method and an application thereof. The metal bipolar plate protective coating of the fuel cell of the present disclosure includes a corrosion barrier layer, a plasma oxide layer and a conductive functional layer sequentially stacked; where the corrosion barrier layer is Hf, metal Nb can be used as a replacement for metal Hf, and the plasma oxide layer is HfO₂ and has a thickness of 2 nm-4 nm. The metal bipolar plate protective coating of the fuel cell of the present disclosure has a corrosion current density less than 1 μA/cm² and a contact resistance less than 10 mΩ·cm². Further, the coating does not peel off easily when corroded for 7200 min under the condition of 1.2 V constant potential.

### TECHNICAL FIELD

The present disclosure relates to the field of metal bipolar plates of fuel cells, and in particular to a metal bipolar plate protective coating of a fuel cell, and a preparation method and an application thereof.

### BACKGROUND

A proton exchange membrane fuel cell (PEMFC) uses hydrogen as a raw material and oxygen in the air as an oxidant as an energy conversion device, and features high energy conversion efficiency, high power density, and pollution-free emission. A bipolar plate, a crucial component in the PEMFC, mainly separates reactive materials (H₂ and O₂), collects current, supports electrodes and connecting cells in series in the fuel cells.

Although a bipolar plate of a conventional fuel cell mostly uses graphite as a raw material, graphite and its composite materials are unsuitable for large-scale commercialization since they are brittle and costly to process. In contrast, for a fuel cell stack, stainless steel is a preferred choice since it has higher strength, is easier in processing and forming, and has lower gas permeability and cost. However, in the acidic and high-temperature working environment of the fuel cell, metal ions precipitated from the stainless steel reduce the activity of a catalyst. A passivation film is also formed on the surface of the stainless steel, which increases a contact resistance between the bipolar plate and a gas diffusion layer, and further decreases the working efficiency of the cell. In view of that, a currently common method is to add a protective coating on the stainless steel metal bipolar plate for improving its corrosion resistance without increasing the contact resistance.

In order to solve the above problems, in the prior art, single-layer or multi-layer protective coatings in the form of nitride, carbide, amorphous carbon, etc. are often deposited on the surface of the metal bipolar plate. Due to inherent features of the physical vapor deposition (PVD) process, there are cracks, holes, etc. in the protective coating in the single-layer structure, and a corrosive solution corrodes a bottom corrosion barrier layer after flowing through the holes. A corrosion potential exceeding a pitting potential leads to the loss of bottom elements, peeling of the surface carbon coating, corrosion of a bipolar plate matrix and a failure to form effective corrosion protection. Despite that the composite coating in the multi-layer structure can effectively block a corrosion channel, the multi-layer structure is also inevitably penetrated by a corrosive solution in a long-term test under the simulated fuel cell condition, resulting in corrosion of a matrix. A metal bipolar plate protective coating of a fuel cell, and a preparation method and an application thereof are disclosed in the prior art. A Ti or Cr metal transition layer and an amorphous carbon layer are sequentially deposited on a matrix of a metal bipolar plate. The lowest contact resistance can be 1.125 mΩ·cm², and the lowest corrosion current density can be 0.1 μA/cm² at a cathode potential (+0.6Vvs_{Ag/AgCl}). In spite of the low contact resistance and the low corrosion current density, the protective coating still peels at the high potential.

### SUMMARY

An objective of the present disclosure is to overcome the defect and shortcoming that an existing metal bipolar plate protective coating in a multilayer structure peels off easily under the condition of a high potential, and provide a metal bipolar plate protective coating of a fuel cell, which features high conductivity, corrosion resistance and does not peel off easily.

Another objective of the present disclosure is to provide a preparation method of the metal bipolar plate protective coating of the fuel cell.

The objective of the present disclosure is implemented by a following technical solution:

A metal bipolar plate protective coating of a fuel cell includes a corrosion barrier layer, a plasma oxide layer and a conductive functional layer sequentially stacked; where

the corrosion barrier layer is Hf, metal Nb can be used as a replacement for metal Hf, and

the plasma oxide layer is HfO₂ with a thickness of 2 nm-4 nm.

A metal bipolar plate matrix is made from 304 stainless steel and/or Ti-6Al-4V titanium alloy. The corrosion barrier layer directly covers a surface of the metal bipolar plate matrix.

According to the metal bipolar plate protective coating of the fuel cell of the present disclosure, the metal Hf coating with an excellent corrosion resistance, a compact structure and excellent toughness is used as the corrosion barrier layer for protecting the metal bipolar plate matrix, such that automatic adaption to rapid oxidization, and automatic repairing of cracks can be implemented.

According to the metal bipolar plate protective coating of the fuel cell of the present disclosure, the plasma oxide layer is constructed between the corrosion barrier layer and the conductive functional layer, and a pitting potential of the plasma oxide layer is higher than that of the pure metal Hf layer, such that coating peeling caused by pitting corrosion of the pure metal Hf at a high potential is prevented, diffusions of a corrosive medium, ions and electrons may be regulated, a corrosive solution of a carbon layer corrosion channel are blocked, and a corrosion rate is controlled. The corrosion rate is capable of being reduced through a plasma oxide layer with a specific thickness without significantly increasing a contact resistance of the coating, the corrosion resistance of the coating is capable of being improved, and high conductivity and corrosion resistance are achieved.

Further, the metal bipolar plate protective coating of the fuel cell of the present disclosure has long-term corrosion resistance since the plasma oxide layer improves a pitting potential of the corrosion barrier layer, and the coating has no sign of peeling in a constant potential test.

The conductive functional layer in the metal bipolar plate protective coating of the fuel cell of the present disclosure is conducive to reduction of a surface contact resistance of the coating.

Further, the metal bipolar plate protective coating of the fuel cell of the present disclosure is capable of reducing a corrosion current, thus showing a self-adaptive repair function.

Optionally, the corrosion barrier layer has a thickness of 550 nm-600 nm.

Optionally, the conductive functional layer is an amorphous carbon coating. A high content of sp² bonds in the amorphous carbon coating is capable of reducing contact resistance and improving conductivity. Further, carbon has stable chemical property and is capable of protecting the corrosion barrier layer.

Optionally, the conductive functional layer has a thickness of 100 nm-150 nm.

The present disclosure further provides a preparation method of any metal bipolar plate protective coating of the fuel cell described above. The preparation method includes:

S1, depositing a corrosion barrier layer: depositing metal Hf on a surface of a metal bipolar plate matrix by adopting a high-power impulse magnetron sputtering (HiPIMS) technology to obtain the corrosion barrier layer;

S2, preparing a plasma oxide layer: adopting an ion beam modification process, generating oxygen plasma by an ion source, and constructing the plasma oxide layer on a surface of the corrosion barrier layer in the S1; and

S3, depositing a conductive functional layer: depositing an amorphous carbon coating on a surface of the plasma oxide layer in the S2 by adopting a direct current magnetron sputtering technology and taking graphite as a sputtering target; where

the depositing the corrosion barrier layer in the S1 includes depositing a metal Hf coating, and the plasma oxide layer in the S2 is an HfO₂ plasma oxide layer.

According to the present disclosure, a physical vapor deposition (PVD) method is used, and the HiPIMS technology is used for preparing a metal Hf coating with an excellent corrosion resistance, a compact structure and excellent toughness as the corrosion barrier layer for protecting the metal bipolar plate matrix. Then, oxygen-containing plasma is introduced into a furnace chamber through an ion source by using the ion beam modification process, and the oxygen-containing plasma bombards the modified metal Hf corrosion barrier layer to generate the HfO₂ plasma oxide layer. Finally, the amorphous carbon conductive functional layer is constructed on the oxide layer by using a direct current magnetron sputtering (DCMS) technology, so as to prepare the composite structure coating.

Optionally, during the depositing the corrosion barrier layer by adopting the HiPIMS technology in the S1, the metal Hf is used as a sputtering target, an output pulse width is 50 μs, a frequency is 500 Hz, a target power is 4 kW, and a gas pressure is 0.55 Pa-0.6 Pa. A purity of the metal Hf is 99.9% or above.

Optionally, during the preparing the plasma oxide layer by adopting the ion beam modification process in the S2, plasma modification time is 10 s-20 s, a power of the ion source is 1 kW, a O₂ flow rate is 300 sccm, and a bias voltage is-200 V.

The reduction of plasma oxidation time is capable of reducing the thickness of oxide layer, and then affects an entire corrosion rate of the coating.

Optionally, during the preparing the amorphous carbon coating by adopting the direct current magnetron sputtering technology in the S3, the graphite is used as a target, argon is introduced, an arc evaporation graphite target current and bias voltage are set, the gas pressure is 0.4 Pa, and a bias voltage applied to the metal bipolar plate matrix is −50 V to −100 V.

The present disclosure further provides an application of any metal bipolar plate protective coating of the fuel cell described above in preparing the fuel cell.

The present disclosure further provides a fuel cell. The fuel cell includes any metal bipolar plate protective coating of the fuel cell described above.

Compared with the prior art, the present disclosure has following beneficial effects:

The metal bipolar plate protective coating of the fuel cell of the present disclosure includes the corrosion barrier layer, the plasma oxide layer and the conductive functional layer sequentially stacked; where the corrosion barrier layer is Hf, metal Nb can be used as a replacement for metal Hf, and the plasma oxide layer is HfO₂ and has a thickness of 2 nm-4 nm. The metal bipolar plate protective coating of the fuel cell of the present disclosure has the high conductivity and corrosion resistance, a corrosion current density is less than 1 μA/cm², and the contact resistance is less than 10 mΩ·cm². Further, the coating does not peel off easily when corroded for 7200 min under the condition of 1.2 V constant potential.

### BRIEF DESCRIPTION OF THE DRAWINGS

FIG. 1 shows a schematic structural diagram of a metal bipolar plate protective coating of a fuel cell in Embodiment 1, and in FIG. 1, 1—a corrosion barrier layer, 2—a plasma oxide layer, 3—a conductive functional layer and 4—a metal bipolar plate matrix.

FIG. 2 shows curve graphs of electrokinetic potential polarization of a metal bipolar plate protective coating of a fuel cell according to Embodiments 1˜4 and Comparative examples 1-3.

FIG. 3 shows an electron micrograph of a surface of a sample after corrosion of the metal bipolar plate protective coating of the fuel cell according to Embodiment 1.

FIG. 4 shows an electrokinetic potential polarization curve of a sample being corroded for 7200 min at a constant potential of 1.2 V according to an embodiment.

FIG. 5 shows constant potential polarization curves of three samples being corroded for 7200 min at a constant potential of 1.2 V according to comparative examples.

### DETAILED DESCRIPTION OF THE EMBODIMENTS

The present disclosure is further described in conjunction with specific embodiments, but embodiments do not limit the present disclosure in any form. Unless otherwise specified, raw material reagents used in the embodiments of the present disclosure are conventionally purchased raw material reagents.

### Embodiment 1

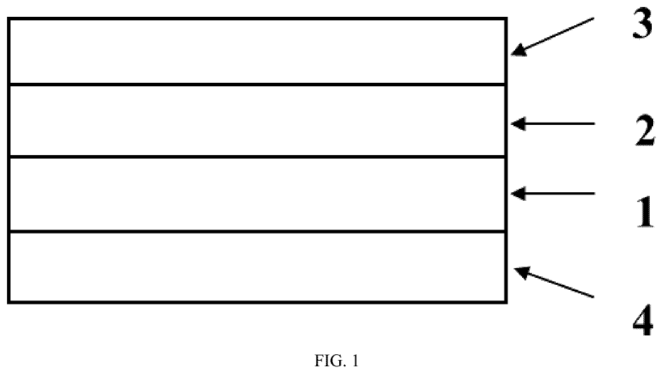

As shown in FIG. 1, a metal bipolar plate protective coating of a fuel cell includes a metal bipolar plate matrix 4 and the protective coating covering a surface of the metal bipolar plate matrix 4, and the protective coating includes a corrosion barrier layer 1, a plasma oxide layer 2 and a conductive functional layer 3 sequentially stacked.

The corrosion barrier layer 1 is Hf and has a thickness of 550 nm.

The plasma oxide layer 2 is HfO₂ and has a thickness of 2 nm.

The conductive functional layer 3 is an amorphous carbon coating and has a thickness of 150 nm.

The metal bipolar plate protective coating of a fuel cell may be prepared by the preparation method as follows:

a matrix is pretreated: a 304 stainless steel matrix is mechanically ground and polished, then ultrasonic cleaning is performed by using a metal cleaner and deionized water for 10 min, then ultrasonic cleaning is performed by using an ethanol absolute solution that has a volume fraction ≥99.8% for 10 min, then the matrix is taken out, and ultrasonically cleaned by using ultrapure water for 3 min, and finally, glow treatment is performed on the metal matrix. Glow cleaning treatment is performed: the matrix is cleaned by using Ar gas ion source for 30 min, a furnace chamber pressure is 1.5 Pa, a matrix bias voltage is −900 V and a duty cycle is 70%.

S1, a corrosion barrier layer is deposited: a metal Hf coating is prepared by adjusting an output pulse width of a high-power impulse magnetron power supply to 50 μs, a frequency to 500 Hz, a target power to 4 kW, and a gas pressure to 0.6 Pa.

S2, a plasma oxide layer is prepared: a power of an ion source is controlled to 1 kW, a bias voltage is −200 V, oxygen is introduced into a furnace chamber through the ion source, an oxygen flow rate is 300 sccm, an etching time is 10 s, and the metal Hf film coating is bombarded by using oxygen-containing plasma to construct the plasma oxide layer on a surface of the metal Hf coating.

S3, a conductive functional layer is deposited: a graphite target is sputtered by adopting a direct current magnetron sputtering technology, a power of a direct current power supply is controlled to 2 kw, a deposition pressure is 0.4 Pa, a bias voltage is adjusted to −50V, and an amorphous carbon coating is deposited on a surface of a plasma oxide in an Ar atmosphere.

### Embodiment 2

A metal bipolar plate protective coating of a fuel cell includes a metal bipolar plate and a protective coating covering a surface of the metal bipolar plate, and the protective coating includes a corrosion barrier layer, a plasma oxide layer and a conductive functional layer sequentially stacked.

The corrosion barrier layer is Hf and has a thickness of 550 nm.

The plasma oxide layer is HfO₂ and has a thickness of 4 nm.

The conductive functional layer is an amorphous carbon coating and has a thickness of 150 nm.

A preparation method of the metal bipolar plate protective coating of the fuel cell is basically the same as that of Embodiment 1 except for the difference that etching time in the S2 is 20 s.

### Embodiment 3

A metal bipolar plate protective coating of a fuel cell includes a metal bipolar plate and a protective coating covering a surface of the metal bipolar plate, and the protective coating includes a corrosion barrier layer, a plasma oxide layer and a conductive functional layer sequentially stacked.

The corrosion barrier layer is Hf and has a thickness of 550 nm.

The plasma oxide layer is HfO₂ and has a thickness of 2 nm.

The conductive functional layer is an amorphous carbon coating and has a thickness of 150 nm.

The difference from Embodiment 1 lies in that a metal bipolar plate matrix is a Ti-6Al-4V titanium alloy.

The remaining contents are the same as that of Embodiment 1, and are not repeated any more herein.

### Embodiment 4

A metal bipolar plate protective coating of a fuel cell includes a metal bipolar plate and a protective coating covering a surface of the metal bipolar plate, and the protective coating includes a corrosion barrier layer, a plasma oxide layer and a conductive functional layer sequentially stacked.

The corrosion barrier layer is Hf and has a thickness of 550 nm.

The plasma oxide layer is HfO₂ and has a thickness of 2 nm.

The conductive functional layer is an amorphous carbon coating and has a thickness of 150 nm.

A preparation method of the metal bipolar plate protective coating of the fuel cell is basically the same as that of Embodiment 1 except for the difference that a bias voltage in the S3 is adjusted to −100 V.

### Comparative Example 1

A metal bipolar plate protective coating of a fuel cell includes a metal bipolar plate and a protective coating covering a surface of the metal bipolar plate the protective coating includes a corrosion barrier layer and a conductive functional layer sequentially stacked.

The protective coating has a thickness of 700 nm, the corrosion barrier layer is Hf and has a thickness of 550 nm, and the conductive functional layer is an amorphous carbon coating and has a thickness of 150 nm.

A preparation method of the metal bipolar plate protective coating of the fuel cell is basically the same as that of Embodiment 1 except for the difference that the S2, a plasma oxide layer is prepared is not included.

### Comparative Example 2

A metal bipolar plate protective coating of a fuel cell includes a metal bipolar plate and a protective coating covering a surface of the metal bipolar plate, and the protective coating includes a corrosion barrier layer, a plasma oxide layer and a conductive functional layer sequentially stacked.

The corrosion barrier layer is Hf and has a thickness of 550 nm.

The plasma oxide layer is HfO₂ and has a thickness of 1 nm.

The conductive functional layer is an amorphous carbon coating and has a thickness of 150 nm.

A preparation method of the metal bipolar plate protective coating of the fuel cell is basically the same as that of Embodiment 1 except for the difference that etching time in the S2 is 5 s.

### Comparative Example 3

A metal bipolar plate protective coating of a fuel cell includes a metal bipolar plate and a protective coating covering a surface of the metal bipolar plate, and the protective coating includes a corrosion barrier layer, a plasma oxide layer and a conductive functional layer sequentially stacked.

The corrosion barrier layer is Hf and has a thickness of 550 nm.

The plasma oxide layer is HfO₂ and has a thickness of 6 nm.

The conductive functional layer is an amorphous carbon coating and has a thickness of 150 nm.

A preparation method of the metal bipolar plate protective coating of the fuel cell is basically the same as that of Embodiment 1 except for the difference that etching time in the S2 is 30 s.

### Performance Test

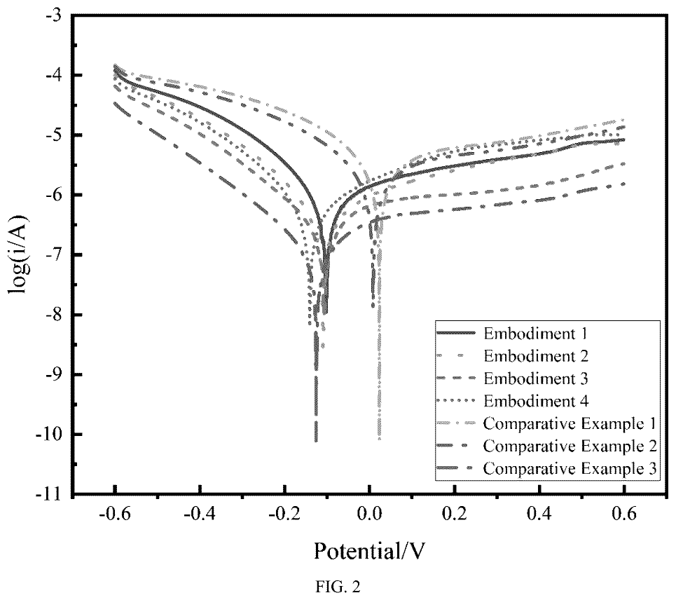

The metal bipolar plate protective coatings prepared in the above embodiments and comparative examples are subjected to a performance test by a specific test method as follows:
(1) An electrokinetic potential polarization test is performed: test conditions include: PH=3, H₂SO₄+2 ppm HF solution and a temperature kept at 70° C.; and the test method uses −0.6 V-0.6 V electrokinetic potential scanning, and a corrosion current density and a corrosion potential are obtained. The test results are shown in FIG. 2 and Table 1.
(2) A contact resistance is as follows: a Merrick RK2514 precision resistance meter and an AGS-X 50KN electronic universal testing machine manufactured by Shimadzu Corporation, Japan are used jointly for testing. The test condition includes an applied pressure of 1.4 Mpa. A test method includes a total resistance R1 of a test model is tested under the pressure of 1.4 Mpa, where R₁=2 (R_{B}+R_{BC}+R_{C}+R_{CD})+R_{D} (R_{B} denotes a resistance of a copper sheet to be tested, R_{BC} denotes a contact resistance between a copper sheet and carbon paper, R_{C} denotes a resistance of Toray carbon paper, R_{CD} denotes a contact resistance tested, and R_{D} denotes a resistance of the matrix itself). Then, under the conditions that the sample is also removed under the pressure of 1.4 Mpa, and only one piece of carbon paper is kept, the total resistance R₂=2R_{B}+2R_{BC}+R_{C} is tested. The contact resistance R_{CD}=(R₁−R₂)/2 may be obtained since a resistance between R_{C} and R_{D} is much smaller than that of R_{CD}. The test results are shown in Table 1.
(3) A constant potential polarization test is performed: test conditions include: PH=3, H₂SO₄+2 ppm HF solution and a temperature kept at 70° C.; and the test method is a constant potential test for 7200 min under the constant potential condition of 1.2 V.

A corrosion current density refers to a corrosion current intensity on a metal surface per unit area. The lower the corrosion current density in an electrochemical corrosion test of the metal bipolar plate protective coating is, the lower a corrosion rate is, which indicates that the metal bipolar plate protective coating has strong corrosion resistance. The contact resistance is the resistance between the metal bipolar plate protective coating and a gas diffusion layer. The smaller the contact resistance is, the less an energy loss in a practical application is. The corrosion resistance and conductivity jointly affect application reliability of the metal bipolar plate in the fuel cell.

TABLE 1
Performance test

| | Thickness | Corrosion | Corrosion | Contact |
|---|---|---|---|---|
| | of an oxide | current density | potential/ | resistance |
| Number. | layer (nm) | (μA/cm²) | V | (mΩ · cm²) |
| Embodiment 1 | 2 | 0.72 | −0.113 | 5.36 |
| Embodiment 2 | 4 | 0.56 | −0.126 | 8.44 |
| Embodiment 3 | 2 | 0.12 | −0.095 | 4.96 |
| Embodiment 4 | 2 | 0.64 | −0.152 | 9.72 |
| Comparative | 0 | 1.68 | 0.036 | 3.62 |
| example 1 | | | | |
| Comparative | 1 | 1.54 | 0.012 | 4.15 |
| example 2 | | | | |
| Comparative | 6 | 0.49 | −0.145 | 19.37 |
| example 3 | | | | |

It can be seen from the above data that the corrosion current density of the metal bipolar plate protective coatings in Embodiments 1-4 is 1 μA/cm² or below at 70° C., PH=3 and H₂SO₄+2 ppm HF solution. The contact resistance is lower than 10 mΩ·cm² at the pressure of 1.4 Mpa, which satisfies the 2020 technical indicators given by the Department of Energy (DOE) of the United States and also satisfies the national standard GB/T 20042.6-2011. Moreover, after a constant potential test of higher than 0.8 V, the coating does not peel off in a large area, and the coating still maintains stability before corrosion.

It can be seen from Embodiments 1 and 2, and Comparative examples 1, 2 and 3 that with prolongation of modification time of the oxygen-containing plasma, the thickness of the plasma oxide layer increases gradually, and the corrosion current density decreases continuously, that is, the long-term corrosion resistance of the protective coating is improved, which shows that plasma oxide layer can delay a corrosion process of the metal matrix. However, with the increase in the thickness of the plasma oxide layer, the contact resistance of the metal bipolar plate also increases. When the plasma thickness is 6 nm, despite that the corrosion resistance is improved, the contact resistance is too large to satisfy the technical requirements of bipolar plate mounting.

It can be seen from Embodiments 1 and 4 that the corrosion current density of Embodiment 4 is lower than that of Embodiment 1, and the contact resistance of Embodiment 4 is higher than that of Embodiment 1. This is because a content of sp³ bonds in an amorphous carbon sample prepared at a bias voltage of 100 V is higher than that in an amorphous carbon sample prepared at a bias voltage of −50 V. The high content of sp³ bonds produce stronger corrosion resistance, and can alleviate corrosion of a underlying coating by the corrosive solution. The conductivity decreases due to the high content of sp³ bonds.

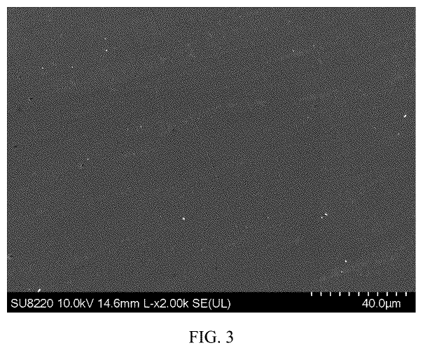

FIG. 3 shows an electron micrograph of a surface of a sample after corrosion of the metal bipolar plate protective coating of the fuel cell according to Embodiment 1. It can be seen from FIG. 3 that the metal bipolar plate protective coating of the fuel cell of the present disclosure has no sign of peeling after corrosion.

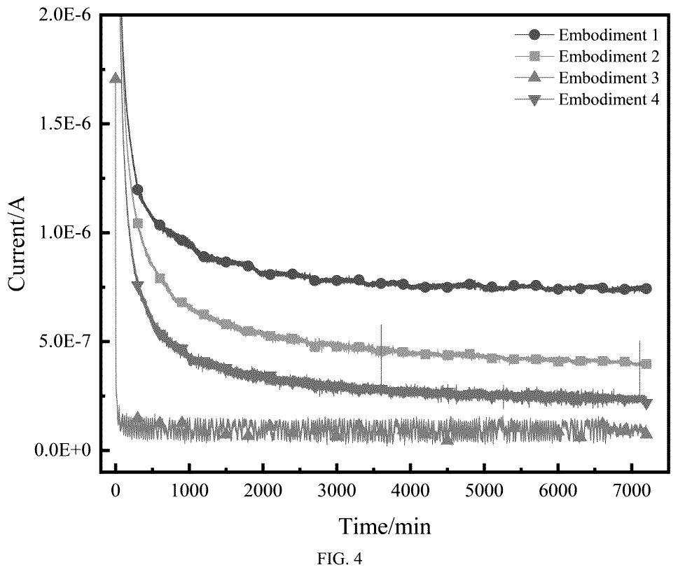

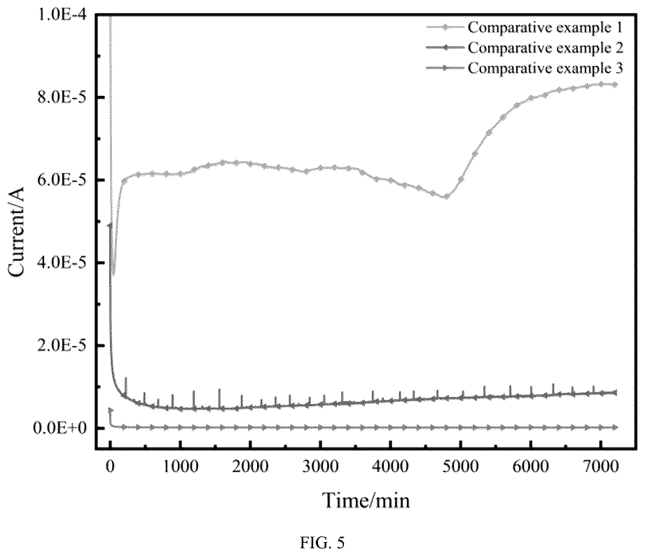

FIG. 4 shows an electrokinetic potential polarization curve of a sample being corroded for 7200 min at a constant potential of 1.2 V according to an embodiment, where a current density is stable. With an increase in the thickness of the plasma oxide layer, the corrosion current density at 1.2 V of Embodiment 2 is lower than the corrosion current density at 1.2 V of Embodiment 1. In Embodiment 3, the corrosion current density at 1.2 V potential is further reduced after a titanium alloy matrix with better corrosion resistance is used. Since the coating prepared by a physical vapor deposition (PVD) process may inevitably have a defect of fine pinhole cracks, and the cracks act as natural channels for corrosive ions to pass therethrough, the corrosive ions may inevitably corrode the matrix, and the matrix with the better corrosion resistance will help improve the overall corrosion resistance. In Embodiment 4, the proportion of sp³ hybrid carbon structure with a stable structure in the surface carbon film is increased by adjusting the bias voltage, and the corrosion current density of Embodiment 4 is lower than the corrosion current density of Embodiment 1. FIG. 5 shows constant potential polarization curves of three samples being corroded for 7200 min at a constant potential of 1.2 V according to comparative examples. It can be seen that in Comparative example 1 and Comparative example 2, due to absence or insufficient thicknesses of plasma oxide layers, the constant potential curves fluctuate greatly and the corrosion resistance of the coatings is decreased. However, in Comparative example 3, after the thickness of the plasma oxide layer is increased to 6 nm, the constant potential of the coating is stable and shows a low current density, but a contact resistance of the coating increases, which fails to satisfy use requirements. It can be seen from FIGS. 4 and 5 that the corrosion resistance, after long-term constant potential polarization, of the metal bipolar plate protective coating of a fuel cell of the present disclosure is obviously superior to that of the Comparative example.

The above examples of the present disclosure are merely instances for clearly describing the present disclosure, rather than limiting the embodiments of the present disclosure. Those skilled in the art can further make other modifications or changes in different forms on the basis of the above description. It is unnecessary or impossible to enumerate all embodiments herein. Any modification, equivalent substitution, improvement, etc. made within the spirit and principles of the present disclosure should fall within the protection scope of the claims of the present disclosure.

What is claimed is:

1. A metal bipolar plate protective coating of a fuel cell, comprising a corrosion barrier layer, a plasma oxide layer and a conductive functional layer sequentially stacked; wherein
the corrosion barrier layer is Hf, metal Nb can be used as a replacement for metal Hf, and
the plasma oxide layer is HfO₂ and has a thickness of 2 nm-4 nm.

2. The metal bipolar plate protective coating of the fuel cell according to claim 1, wherein the corrosion barrier layer has a thickness of 550 nm-600 nm.

3. The metal bipolar plate protective coating of the fuel cell according to claim 1, wherein the conductive functional layer is an amorphous carbon coating.

4. The metal bipolar plate protective coating of the fuel cell according to claim 1, wherein the conductive functional layer has a thickness of 100 nm-150 nm.

5. A preparation method of the metal bipolar plate protective coating of the fuel cell according to claim 1, comprising:
S1, depositing a corrosion barrier layer: depositing metal Hf on a surface of a metal bipolar plate matrix by adopting a high-power impulse magnetron sputtering technology to obtain the corrosion barrier layer;
S2, preparing a plasma oxide layer: adopting an ion beam modification process, generating oxygen plasma by an ion source, and constructing the plasma oxide layer on a surface of the corrosion barrier layer in the S1; and
S3, depositing a conductive functional layer: depositing an amorphous carbon coating on a surface of the plasma oxide layer in the S2 by adopting a direct current magnetron sputtering technology and taking graphite as a sputtering target; wherein
the depositing the corrosion barrier layer in the S1 comprises depositing a metal Hf coating, and the plasma oxide layer in the S2 is an HfO₂ plasma oxide layer.

6. The preparation method according to claim 5, wherein during the depositing the corrosion barrier layer by adopting the high-power impulse magnetron sputtering technology in the S1, the metal Hf is used as a sputtering target, an output pulse width is 50 μs, a frequency is 500 Hz, a target power is 4 kW, and a gas pressure is 0.55 Pa-0.6 Pa.

7. The preparation method according to claim 5, wherein during the preparing the plasma oxide layer by adopting the ion beam modification process in the S2, plasma modification time is 10 s-20 s, a power of the ion source is 1 kW, a O₂ flow rate is 300 sccm, and a bias voltage is −200 V.

8. The preparation method according to claim 5, wherein during the preparing the amorphous carbon coating by adopting the direct current magnetron sputtering technology in the S3, the graphite is used as a target, argon is introduced, a deposition gas pressure is 0.4 Pa, and a bias voltage applied to the metal bipolar plate matrix is −50 V to −100 V.

9. An application of the metal bipolar plate protective coating of the fuel cell according to claim 1 to preparation of the fuel cell.

10. A fuel cell, comprising the metal bipolar plate protective coating of the fuel cell according to claim 1.
